(19) United States
(12) Patent Application Publication
(10) Pub. No.: US 2024/0311061 A1
(43) Pub. Date: Sep. 19, 2024

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Kazuya Nakashima, Kanagawa (JP)

(21) Appl. No.: 18/598,064

(22) Filed: Mar. 7, 2024

(30) Foreign Application Priority Data
Mar. 17, 2023 (JP) 2023-043461

(51) Int. Cl. G06F 3/12; G06F 21/60

(52) U.S. Cl. CPC G06F 3/1222; G06F 3/1238; G06F 21/608

(57) ABSTRACT

An information processing apparatus acquires a print instruction designated to be executed by a first method that does not need a user operation on a print apparatus to start print. When the print instruction designated to be executed by the first method is acquired, the apparatus determines, based on at least one of a date/time to execute print and a position of the print apparatus, whether an information leakage risk is higher than a threshold. The apparatus executes the print instruction by the first method in a case where it is determined that the information leakage risk is lower than the threshold, and executes the print instruction by a second method that needs the user operation on the print apparatus to start print in a case where it is determined that the information leakage risk is higher than the threshold.

### BACKGROUND OF THE INVENTION

### Field of the Invention

The present invention relates to an information processing apparatus, an information processing method, and a non-transitory computer-readable storage medium.

### Description of the Related Art

Japanese Patent No. 6237576 proposes a pull print system in which a print job is managed on a server based on the authentication information of a user, and an image forming apparatus performs print via the server. In pull print, only a print job selected on a printer is the print target, there is little risk that a third party views a printed product, or a printed product is lost. A method that needs a user operation in a print apparatus to start print, like pull print, can implement high security. In this method, however, since print is not started until the user operation is performed, it may take a standby time until the end of print. Additionally, the user may find the operation cumbersome. For this reason, user's convenience decreases. On the other hand, in a method that does not need a user operation in the print apparatus to start print, a printed product may be seen by a third party or lost, resulting in information leakage.

### SUMMARY OF THE INVENTION

An aspect of the present disclosure provides a technique for reducing the risk of information leakage by execution of print without impairing user's convenience.

According to some embodiments, an information processing apparatus comprising: an acquisition unit configured to acquire a print instruction designated to be executed by a first method that does not need a user operation on a print apparatus to start print; a determination unit configured to, in a case where the acquisition unit acquires the print instruction designated to be executed by the first method, determine, based on at least one of a date/time to execute print according to the print instruction and a position of the print apparatus that executes print according to the print instruction, whether an information leakage risk caused by execution of print according to the print instruction is higher than a threshold; and an execution unit configured to execute the print instruction by the first method in a case where it is determined that the information leakage risk is lower than the threshold, and execute the print instruction by a second method that needs the user operation on the print apparatus to start print in a case where it is determined that the information leakage risk is higher than the threshold is provided.

Further features of the present invention will become apparent from the following description of exemplary embodiments with reference to the attached drawings.

### BRIEF DESCRIPTION OF THE DRAWINGS

FIG. 1 is a block diagram for explaining an example of the configuration of a print system according to some embodiments;

FIG. 2 is a block diagram for explaining an example of the hardware configuration of a computer according to some embodiments;

FIG. 3 is a block diagram for explaining an example of the functional configuration of a print apparatus according to some embodiments;

FIG. 4 is a block diagram for explaining an example of the functional configuration of a print server according to some embodiments;

FIG. 5 is a block diagram for explaining an example of the functional configuration of a client apparatus according to some embodiments;

FIG. 6 is a flowchart for explaining an example of the operation of the print server according to some embodiments;

FIGS. 7A to 7C are schematic views for explaining examples of various screens according to some embodiments;

FIG. 8 is a flowchart for explaining an example of the operation of the print server according to some embodiments; and

FIGS. 9A and 9B are schematic views for explaining examples of various screens according to some embodiments.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

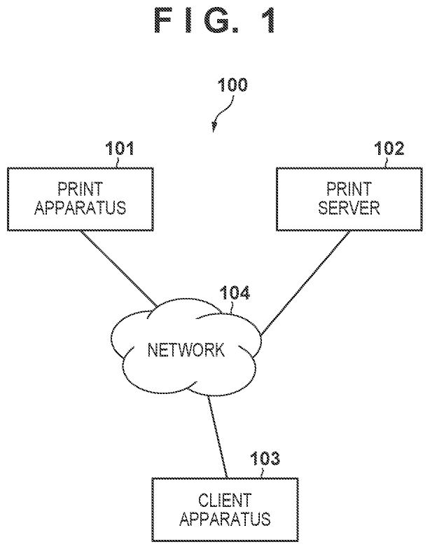

An example of the configuration of a print system 100 according to some embodiments will be described with reference to FIG. 1. The print system 100 includes, for example, a print apparatus 101, a print server 102, and a client apparatus 103. The print server 102 acquires a print instruction from the client apparatus 103, and instructs the print apparatus 101 to perform print in accordance with the print instruction. The operation of the print server 102 can also be called a print service. Although FIG. 1 shows only one client apparatus 103, one print server 102 may provide the print service to a plurality of client apparatuses 103. Although FIG. 1 shows only one print apparatus 101, one print server 102 may provide the print service using a plurality of print apparatuses 101.

The print apparatus 101 is an apparatus capable of executing print in accordance with an instruction from the print server 102. The print apparatus 101 can also be called an image forming apparatus. The print apparatus 101 may be a single function print apparatus including only a print function as a main function. Instead, the print apparatus 101 may be a multifunctional apparatus having a print function and other functions (for example, scan, copy, FAX transmission, and the like) as main functions. The multifunctional apparatus can also be called a Multi Function Peripheral (MFP). The print apparatus 101 may be able to execute not only print according to a print instruction received from the print server 102 but also print according to a print instruction directly received from the client apparatus 103 (that is, without interposing the print server 102). The print apparatus 101 may be able to execute print on a sheet-shaped print medium such as paper, or may be able to execute three-dimensional print for forming an object.

The print server 102 has a function of performing management associated with the print service such as management of the print apparatus 101, management of users, management of print jobs, and management of print history. The print server 102 acquires, from the client apparatus 103, a print instruction that the user has input using the client apparatus 103. The print server 102 generates a print job in accordance with the print instruction, and transmits the print job to the print apparatus 101 designated by the print instruction.

In this specification, an instruction that the user performs an input to the client apparatus 103 or via the client apparatus 103 will be referred to as a print instruction. Also, an instruction generated by the print server 102 in accordance with the print instruction and transmitted to the print apparatus 101 will be referred to as a print job. In other words, the print job may be a print instruction performed by the print server 102.

Transmitting a print job according to a print instruction from the print server 102 to the print apparatus 101 will simply be referred to as “the print server 102 executes a print instruction” hereinafter. If the print apparatus 101 executes a print job, print according to a print instruction designated by the user is executed.

The print server 102 may be able to execute a print instruction by a plurality of methods. The plurality of methods executable by the print server 102 may include a method that does not need a user operation in the print apparatus 101 to start print. In the following explanation, this method will be referred to as push print hereinafter. The print server 102 that executes push print acquires a print instruction from the client apparatus 103, and then transmits a print job to the print apparatus 101 without any additional operation by the user. Thus, the print apparatus 101 starts print according to the print instruction.

The plurality of methods executable by the print server 102 may include a method that needs a user operation in the print apparatus 101 to start print. In the following explanation, this method will be referred to as hold printing hereinafter. Hold printing can also be called pull print. The print server 102 that executes hold printing acquires a print instruction from the client apparatus 103, and then waits for a user operation in the print apparatus 101. If the user operation is performed in the print apparatus 101, the print server 102 transmits a print job to the print apparatus 101. Thus, the print apparatus 101 starts print according to the print instruction.

The client apparatus 103 is an apparatus that the user uses to use the print service provided by the print server 102. The client apparatus 103 can also be called a client terminal, a user apparatus, a user terminal, or the like. For example, the client apparatus 103 may be a personal computer, a smartphone, a tablet computer, or the like. The client apparatus 103 may transmit a print instruction from the user to the print server 102 using a web browser, or may transmit a print instruction from the user to the print server 102 using a dedicated application. The print instruction can include a print target document instructed by the user.

The print apparatus 101, the print server 102, and the client apparatus 103 are connected to a network 104. The print apparatus 101 and the print server 102 can communicate with each other via the network 104. The client apparatus 103 and the print server 102 can communicate with each other via the network 104. The print apparatus 101 and the client apparatus 103 may be able to communicate with each other or not. The network 104 may be formed by a Local Area Network (LAN), a Wide Area Network (WAN), the Internet, a telephone line, a dedicated digital line, or an Asynchronous Transfer Mode (ATM), or an arbitrary combination thereof. The network 104 can also be called a communication network.

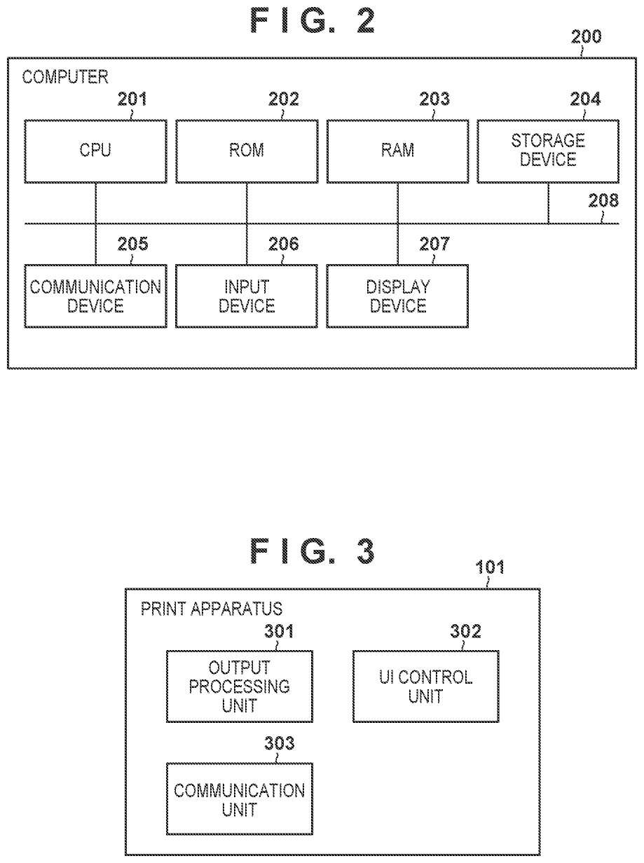

An example of the hardware configuration of a computer 200 according to some embodiments will be described with reference to FIG. 2. The computer 200 can also be called an information processing apparatus. The computer 200 may be used to implement any of the print apparatus 101, the print server 102, and the client apparatus 103. For example, the computer 200 may be used as the print server 102, or may be used as the client apparatus 103. The computer 200 may be incorporated in the print apparatus 101, and in this case, the computer 200 functions as an (internal) control device of the print apparatus 101.

The computer 200 may include constituent elements shown in FIG. 2. According to the type of the apparatus to be implemented, the computer 200 may not include some of the constituent elements shown in FIG. 2, or may include a constituent element not shown in FIG. 2. In the following explanation, a constituent element (for example, a CPU 201) of the computer 200 used to implement the print apparatus 101 will sometimes simply be referred to as a constituent element (for example, the CPU 201) of the print apparatus 101. This also applies to the constituent elements of the print server 102 and the client apparatus 103.

The Central Processing Unit (CPU) 201 controls the overall operation of the computer 200 by controlling the constituent elements connected to a bus 208. For example, if the computer 200 is used to implement the print apparatus 101, the CPU 201 may execute functions such as print and scan.

A Read Only Memory (ROM) 202 is a memory dedicated to data read. The ROM 202 may store programs and data used for the operation of the computer 200. A Random Access Memory (RAM) 203 is a memory capable of data read/write. The RAM 203 may be used as the working memory of the CPU 201.

A storage device 204 may store programs and data used for the operation of the computer 200. The programs and data stored in the storage device 204 may be read out to the RAM 203 for processing by the CPU 201. The storage device 204 may be formed by, for example, a Hard Disk Drive (HDD), a Solid State Drive (SSD), a Compact Disc (CD), a Digital Versatile Disc (DVD), a memory card, or the like.

A communication device 205 is a device configured to communicate with another apparatus via the network 104. The communication device 205 may be a network card to perform wired communication, or may be a communication module to perform wireless communication. The communication device 205 may support data communication by, for example, TCP/IP.

An input device 206 is a device configured to accept an input operation from the user of the computer 200. The input device 206 may be formed by, for example, a keyboard, a mouse, physical buttons, a touch panel, or the like. The computer 200 may have an input interface configured to interact with an input device outside the computer 200, instead of having the input device 206 by itself.

A display device 207 is a device configured to display information to the computer 200. The display device 207 may be formed by, for example, a liquid crystal display, an indicator, or the like. The computer 200 may have an output interface configured to interact with a display device outside the computer 200, instead of having the display device 207 by itself. The input device 206 and the display device 207 may be integrated to form a touch screen.

If the computer 200 is used to implement the print apparatus 101, the computer 200 may include an interface configured to interact with a scanner device or a printer device mounted in the print apparatus 101.

An example of the functional configuration of the print apparatus 101 will be described with reference to FIG. 3. The print apparatus 101 may have functions shown in FIG. 3. The functions of the print apparatus 101 may be implemented by the CPU 201 of the print apparatus 101 executing a program loaded into the RAM 203 of the print apparatus 101. Instead, some or all of the functions of the print apparatus 101 may be implemented by a dedicated integrated circuit such as an Application Specific Integrated Circuit (ASIC). The print apparatus 101 may not include some of the functions shown in FIG. 3, or may include a function not shown in FIG. 3.

An output processing unit 301 performs processing associated with generation of output data to be supplied to the printer device of the print apparatus 101. The output processing unit 301 may generate output data in accordance with a print job acquired from the print server 102 via a communication unit 303 and print the output data using the printer device. A User Interface (UI) control unit 302 controls the display contents of the display device 207 of the print apparatus 101. For example, during execution of print, the UI control unit 302 may display that print is being executed. The communication unit 303 processes communication performed by the print apparatus 101. For example, the communication unit 303 may receive a print command from the print server 102 or receive a print job.

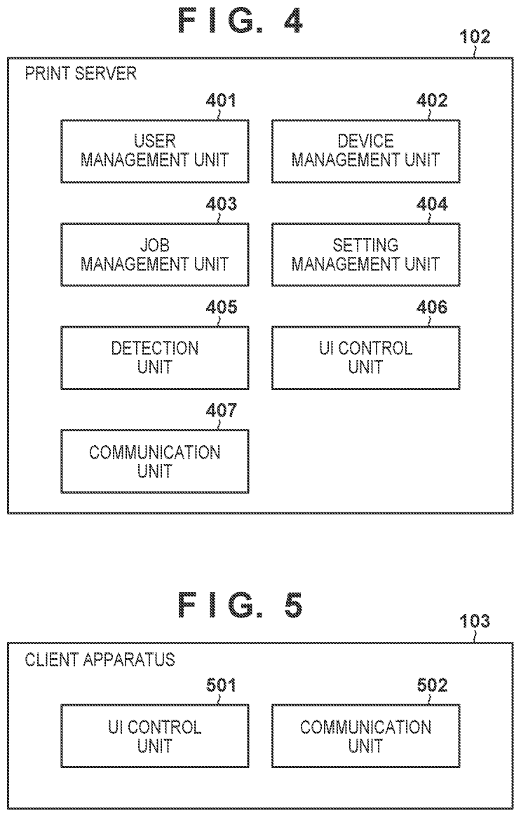

An example of the functional configuration of the print server 102 will be described with reference to FIG. 4. The print server 102 may have functions shown in FIG. 4. The functions of the print server 102 may be implemented by the CPU 201 of the print server 102 executing a program loaded into the RAM 203 of the print server 102. Instead, some or all of the functions of the print server 102 may be implemented by a dedicated integrated circuit such as an ASIC. The print server 102 may not include some of the functions shown in FIG. 4, or may include a function not shown in FIG. 4.

A user management unit 401 manages users who use the print service. The user management unit 401 may manage the users on a tenant basis. A tenant is a unit to which the print server 102 provides the print service. For example, the administrator of the print server 102 may register a user who wants to use the print service in a tenant to which the user belongs. The registered user can use functions provided by the print server 102. The functions provided by the print server 102 can include, for example, a print service for printing a document uploaded to the print server 102 from the print apparatus 101 registered in the print server 102. If the print server 102 is arranged in a cloud environment, the print service can also be called a cloud print service.

A device management unit 402 manages devices used in the print service. The device management unit 402 may manage the devices on a tenant basis. The devices used in the print service may include the print apparatus 101. For example, a user or administrator may register, in a tenant, a device that should be the management target of the print server 102. The user can use the functions of the print server 102 using the registered device.

A job management unit 403 manages print jobs generated by the print server 102. The job management unit 403 may manage the print jobs on a tenant basis. The job management unit 403 may also manage a history (for example, a print history) associated with execution of a print job (for example, execution of print according to a print job). The print history may also include a user who has executed print, an execution date/time, a job name, print setting contents, and the like. The print history may also include an image file associated with the print job.

A setting management unit 404 manages the set values of the functions provided by the print server 102. The set values may be values designated by the user, or may be values designated by the administrator of the print server 102. The set values are stored in, for example, the storage device 204 of the print server 102.

A detection unit 405 calculates an information leakage risk caused by execution of print according to a print job, and determines whether the information leakage risk is higher than a threshold. A detailed calculation method of the information leakage risk will be described later.

A UI control unit 406 controls a UI used to provide the functions of the print server 102. For example, the UI control unit 406 may generate a screen to be displayed on the web browser of the client apparatus 103. Also, the UI control unit 406 may acquire an instruction input, via the screen, by the user of the client apparatus 103.

A communication unit 407 processes communication performed by the print server 102. For example, the communication unit 407 may receive a print instruction from the client apparatus 103, or may transmit a print instruction to the print apparatus 101.

An example of the functional configuration of the client apparatus 103 will be described with reference to FIG. 5. The client apparatus 103 may have functions shown in FIG. 5. The functions of the client apparatus 103 may be implemented by the CPU 201 of the client apparatus 103 executing a program loaded into the RAM 203 of the client apparatus 103. Instead, some or all of the functions of the client apparatus 103 may be implemented by a dedicated integrated circuit such as an ASIC. The client apparatus 103 may not include some of the functions shown in FIG. 5, or may include a function not shown in FIG. 5.

A UI control unit 501 controls the display contents of the display device 207 of the client apparatus 103. A communication unit 502 processes communication performed by the client apparatus 103. For example, the communication unit 502 may transmit a print instruction to the print server 102.

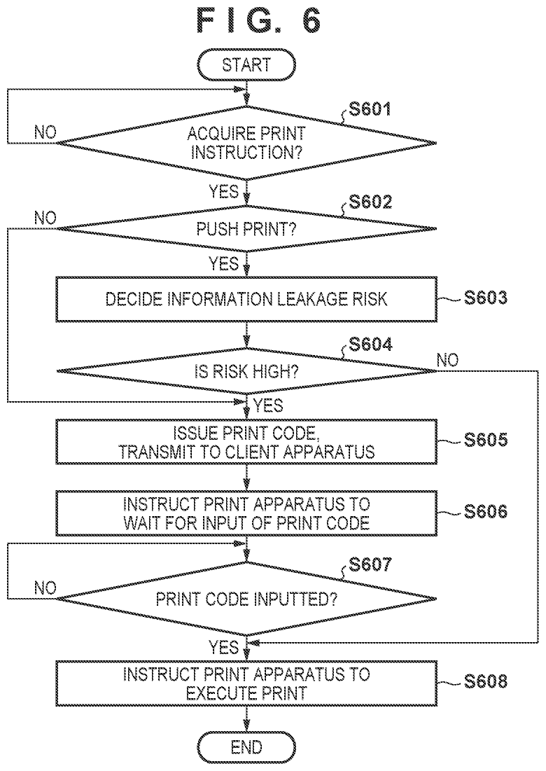

An example of print processing executed by the print server 102 will be described with reference to FIG. 6. The processes of the method shown in FIG. 6 may be executed by, for example, the CPU 201 of the print server 102 executing a program loaded into the RAM 203 of the print server 102. Instead, some or all of the processes of the method shown in FIG. 6 may be executed by a dedicated integrated circuit such as an ASIC. The method shown in FIG. 6 may be started when the print service by the print server 102 is activated by the administrator of the print server 102.

In step S601, the print server 102 (for example, the job management unit 403) determines whether a print instruction is acquired from the client apparatus 103. Upon determining that a print instruction is acquired from the client apparatus 103 (“YES” in step S601), the print server 102 advances the process to step S602. Otherwise (“NO” in step S601), the print server 102 repeats step S601.

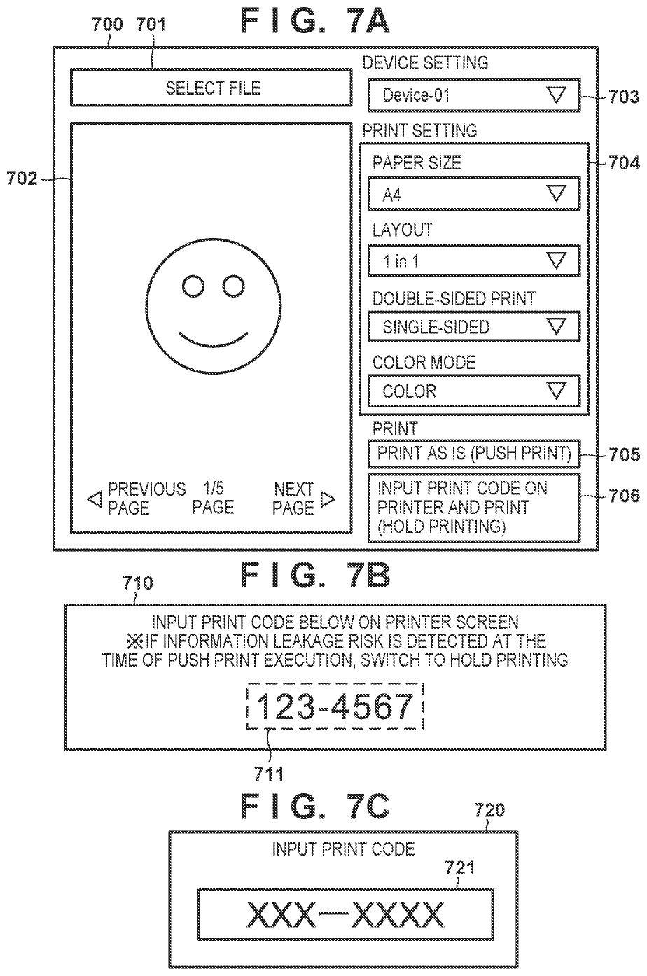

The print server 102 may acquire the print instruction from the user via, for example, a screen 700 shown in FIG. 7A. The screen 700 is an example of a screen displayed on the display device 207 of the client apparatus 103 to acquire the print instruction from the user. The UI control unit 406 of the print server 102 generates data that forms the screen 700, and transmits the data to the client apparatus 103. The UI control unit 501 of the client apparatus 103 generates the screen 700 based on the data, and displays it on the display device 207 of the client apparatus 103. The UI control unit 501 of the client apparatus 103 transmits the instruction acquired from the user via the input device 206 of the client apparatus 103 to the print server 102. The UI control unit 406 of the print server 102 performs processing according to the instruction received from the client apparatus 103. The UI control unit 406 of the print server 102 may be provided by a server-side application, and the UI control unit 501 of the client apparatus 103 may be provided by the web browser. That is, the print server 102 may function as a web application server, and the client apparatus 103 may function as a web application client.

The screen 700 may be displayed when a user registered in the user management unit 401 of the print server 102 is connected to the print server 102 using the web browser in the client apparatus 103 to use the print service. The screen 700 may include objects as shown in FIG. 7A. Each object included in the GUI can also be called a graphic object.

A file selection object 701 is an object (for example, a button) for designating a print target (for example, a document file). If the file selection object 701 is pressed by the user, the UI control unit 406 displays a file selection dialog (not shown). The UI control unit 406 accepts a file selected by the user as a print target. The print target file is uploaded to the job management unit 403 of the print server 102 via the communication unit 502 of the client apparatus 103. Designation of the print target may be performed not by using the file selection dialog but by drag & drop of a file to the screen 700 or the file selection object 701.

A print preview object 702 is an object (display region) for displaying a print preview of the print target selected using the file selection object 701. In the print preview object 702, a preview of a printed image, the total number of pages, a page number under display, and the like may be displayed. Also, the print preview object 702 may include a button used to switch the page under display.

A device setting object 703 is an object (for example, a pulldown list) for selecting a device (print apparatus) to execute print. If the device setting object 703 is pressed, a list of devices registered by the user is displayed, and the user can select one device from the choices.

A print setting object 704 is an object (for example, a plurality of pulldown lists) for doing settings concerning the output contents of a printed product. In the example of the screen 700, the settings of a paper size, layout, double-sided print, and color mode can be changed. These setting items may include choices according to the print capability of the device designated by device setting. In addition, the display of the print preview object 702 may be changed in accordance with the change of the settings using the print setting object 704.

A push print object 705 is an object (for example, a button) for acquiring, from the user, a designation to execute a print instruction by push print. If the push print object 705 is pressed by the user, the UI control unit 501 determines that a print instruction that is designated to be executed by push print is acquired.

A hold printing object 706 is an object (for example, a button) for acquiring, from the user, a designation to execute a print instruction by hold printing. If the hold printing object 706 is pressed by the user, the UI control unit 501 determines that a print instruction that is designated to be executed by hold printing is acquired.

Referring back to FIG. 6, in step S602, the print server 102 (for example, the job management unit 403) determines whether push print is designated by the print instruction acquired in step S601. Upon determining that push print is designated (“YES” in step S602), the print server 102 advances the process to step S603. Otherwise (“NO” in step S602), the print server 102 advances the process to step S605. For this reason, upon determining that hold printing is designated by the print instruction acquired in step S601, the print server 102 advances the process to step S605.

In step S603, the print server 102 (for example, the detection unit 405) decides an information leakage risk caused by execution of print according to the print instruction acquired in step S601. The information leakage risk may be represented by a numerical value, and may indicate that if the numerical value is large, the risk is high. As will be described later, upon determining that the information leakage risk is high, the print server 102 executes the print instruction by hold printing even if push print is designated.

The print server 102 may decide the information leakage risk based on, for example, the contents of the print target designated by the print instruction acquired in step S601. For example, if the print target includes personal information data, the print server 102 may set the information leakage risk to a large value, and if the print target does not include personal information data, the print server 102 may set the information leakage risk to a small value. For example, the print server 102 extracts character information from the print target and determines whether an item corresponding to personal information is included. The item corresponding to personal information may be, for example, a name, a date of birth, a telephone number, or an address. Whether character information corresponding to these items is included may be determined by collating with a regular expression or database information. Upon detecting personal information of a plurality of persons, the print server 102 may set the information leakage risk to a larger value. If the print target includes a keyword set in advance, the print server 102 may set the information leakage risk to a large value, and if the print target does not include such a keyword, the print server 102 may set the information leakage risk to a small value.

The print server 102 may decide the information leakage risk based on, for example, the number of pages of the print target designated by the print instruction acquired in step S601. Print takes longer time if the number of pages of the print target is large. For this reason, if print is performed by push print, the possibility that the printed product is seen by a third party is high. Hence, for example, the print server 102 may set the information leakage risk to a value having positive correlation with (for example, proportional to) the number of pages of the print target.

The print server 102 may decide the information leakage risk based on, for example, the print execution date/time according to the print instruction acquired in step S601. If print is performed by push print on a date/time with few people around the print apparatus 101, like nighttime or a holiday, a third party may peek at the printed product. Hence, for example, if print is executed at nighttime or on a holiday, the print server 102 may set the information leakage risk to a large value, and if print is executed at daytime of a weekday, the print server 102 may set the information leakage risk to a small value.

The print server 102 may decide the information leakage risk based on, for example, the position of the print apparatus that executes print according to the print instruction acquired in step S601. If the print apparatus that executes print is located in the company of the user, it can be considered that the risk that the information of the print target leaks is low. Hence, for example, if the print apparatus that executes print is located outside the company of the user, the print server 102 may set the information leakage risk to a large value, and if the print apparatus that executes print is located in the company of the user, the print server 102 may set the information leakage risk to a small value. The position of the print apparatus may be determined based on, for example, an Internet Protocol (IP) address set in the print apparatus. For example, if the IP address set in the print apparatus that executes print is included in the range of IP addresses set in advance by the administrator of the print server 102, it may be determined that the print apparatus is located in the company of the user.

The print server 102 may decide the information leakage risk based on at least one of the above-described various conditions. For example, the print server 102 may decide the information leakage risk based on each of the above-described plurality of conditions and decide the sum or product of these values as the total information leakage risk (that is, the value used in step S604).

In step S604, the print server 102 (for example, the detection unit 405) determines whether the information leakage risk decided in step S603 is higher than a threshold. Upon determining that the information leakage risk is higher than the threshold (“YES” in step S604), the print server 102 advances the process to step S605. Otherwise (“NO” in step S604), the print server 102 advances the process to step S608. Hence, upon determining that the information leakage risk decided in step S603 is lower than the threshold, the print server 102 advances the process to step S608. In the above-described example, if the information leakage risk equals the threshold, the print server 102 advances the process to step S608. Instead, the print server 102 may advance the process to step S605. The threshold used in the determination of step S604 may be decided in advance by the administrator of the print server 102 in accordance with the information leakage risk decision method and stored in the print server 102.

In a case where a print instruction that is designated to be executed by hold printing is acquired, the print server 102 executes the print instruction by hold printing regardless of whether the information leakage risk is higher than the threshold (more specifically, processing from step S605 is executed). In a case where a print instruction that is designated to be executed by push print is acquired, if the information leakage risk is higher than the threshold, the print server 102 executes the print instruction not by push print but by hold printing (more specifically, processing from step S605 is executed). In a case where a print instruction that is designated to be executed by push print is acquired, if the information leakage risk is lower than the threshold, the print server 102 executes the print instruction by hold printing (more specifically, processing of step S608 is executed).

In step S605, the print server 102 (for example, the UI control unit 406) issues a print code, and transmits the print code to the client apparatus 103. The print code is a code to be input to the print apparatus 101 that executes print according to the print instruction in hold printing. The code may be, for example, a character string of a predetermined number of digits. Instead, the code may be a two-dimensional code. The print server 102 stores the print code in association with the print instruction acquired in step S601.

The UI control unit 406 may generate data that forms a screen including the print code and transmit the data to the client apparatus 103. The UI control unit 501 (for example, the web browser) of the client apparatus 103 may generate a screen based on the data and display it on the display device 207 of the client apparatus 103.

An example of a screen 710 including a print code will be described with reference to FIG. 7B. The screen 710 includes a print code 711. Also, the screen 710 may include a notification representing that push print is changed to hold printing because of the high information leakage risk.

In step S606, the print server 102 (for example, the job management unit 403) instructs the print apparatus 101 designated by the print instruction acquired in step S601 to wait for input of the print code. Upon receiving the instruction, the print apparatus 101 (for example, the UI control unit 302) displays a screen for acquiring the print code on the display device 207 of its own. The print apparatus 101 may automatically display the screen upon receiving the instruction, or may display the screen when the user instructs display of the screen using the input device 206 of the print apparatus 101. In the example shown in FIG. 6, step S606 is executed after step S605. However, step S606 may be executed before step S605.

An example of a screen 720 for acquiring the print code will be described with reference to FIG. 7C. The screen 720 includes a field 721 used to input a print code. If the user inputs the print code using the input device 206 of the print apparatus 101, the print apparatus 101 transmits the print code to the print server 102. If the print code is a two-dimensional code, the print apparatus 101 may capture the two-dimensional code presented by the user.

In step S607, the print server 102 (for example, the job management unit 403) determines whether the user has input the print code issued in step S605 to the print apparatus 101. Upon determining that the user has input the print code (“YES” in step S607), the print server 102 advances the process to step S608. Otherwise (“NO” in step S607), the print server 102 repeats step S607. If the print code received from the print apparatus 101 matches the print code issued in step S605, the print server 102 may determine that the user has input the print code issued in step S605 to the print apparatus 101. If it is not determined that the user has input the print code within a predetermined time (for example, 10 min), the print server 102 may stop execution of the print instruction.

In step S608, the print server 102 (for example, the job management unit 403) generates a print job in accordance with the print instruction acquired in step S601 and transmits the print job to the print apparatus 101 designated by the print instruction. If the print server 102 is to execute the print instruction by hold printing, the print job is transmitted to the print apparatus 101 in step S608 after execution of the processes of steps S605 to S607. If the print server 102 is to execute the print instruction by push print, the print job is transmitted to the print apparatus 101 in step S608 without executing the processes of steps S605 to S607. The print apparatus 101 that has received the print job executes print in accordance with the print job, that is, in accordance with the print instruction by the user.

According to the above-described embodiment, if the information leakage risk caused by execution of print is low, the user can execute print by push print. On the other hand, if the information leakage risk caused by execution of print is high, print is automatically changed to hold printing even if the user designates push print. For this reason, the risk of information leakage by execution of print is reduced without impairing user's convenience.

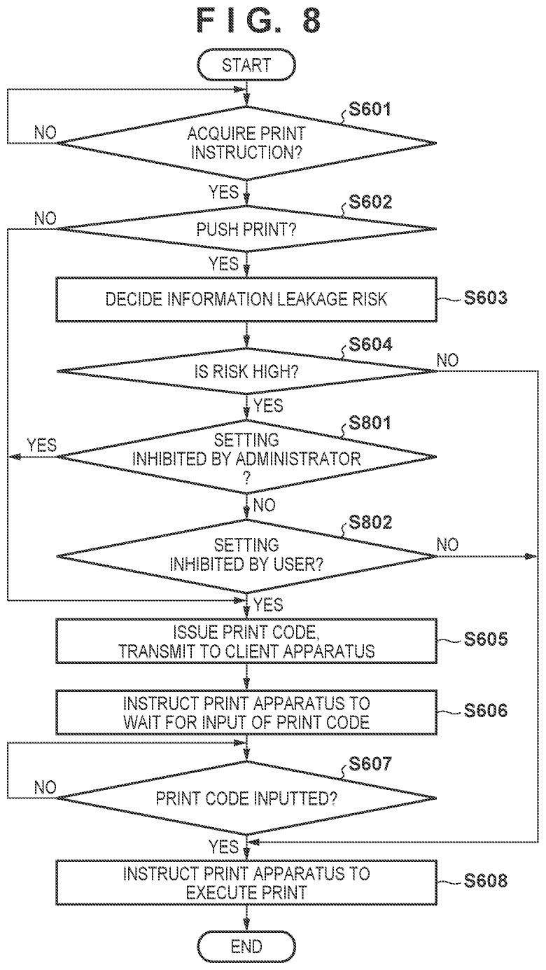

A modification of the above-described embodiment will be described with reference to FIG. 8. In the method according to the above-described embodiment, if the information leakage risk caused by execution of print is high, push print is not executed. However, in some cases, for example, in a case where the user can visually recognize the state around the print apparatus 101, the information leakage risk is low even if push print is executed. Hence, in the modification to described with reference to FIG. 8, even if the print server 102 determines that the information leakage risk is higher than the threshold, push print is executed in accordance with a setting by the user or the administrator of the print server 102.

The processes of the method shown in FIG. 8 may be executed by, for example, the CPU 201 of the print server 102 executing a program loaded into the RAM 203 of the print server 102. Instead, some or all of the processes of the method shown in FIG. 8 may be executed by a dedicated integrated circuit such as an ASIC. The method shown in FIG. 8 may be started when the print service by the print server 102 is activated by the administrator of the print server 102. The method shown in FIG. 8 is different from the method shown in FIG. 6 in that steps S801 and S802 are executed between steps S604 and S605.

The processes of steps S601 to S608 may be the same as the processes described with reference to FIG. 6. In step S604, upon determining that the information leakage risk is higher than the threshold (“YES” in step S604), the print server 102 advances the process to step S801.

In step S801, the print server 102 (for example, the detection unit 405) determines whether inhibiting push print in a case where it is determined that the information leakage risk is higher than the threshold is set by the administrator of the print server 102. Upon determining that the setting is done (“YES” in step S801), the print server 102 advances the process to step S605. Otherwise (“NO” in step S801), the print server 102 advances the process to step S802. The administrator of the print server 102 may be the administrator of the print service provided by the print server 102.

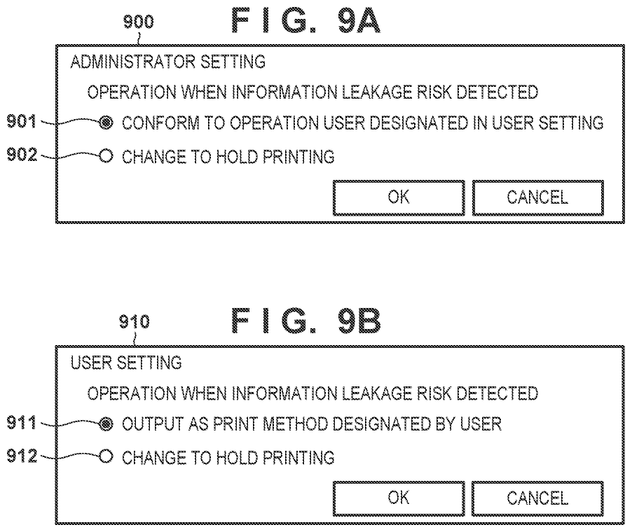

An example of a screen 900 used by the administrator to set whether to inhibit push print in a case where it is determined that the information leakage risk is higher than the threshold will be described with reference to FIG. 9A. The print server 102 (for example, the UI control unit 406) may display the screen 900 on the display device 207 of the print server 102. The screen 900 includes two radio buttons 901 and 902. By selecting the radio button 901, the administrator can set to comply with the setting by the user, concerning whether to inhibit push print in a case where it is determined that the information leakage risk is higher than the threshold. By selecting the radio button 902, the administrator can set to inhibit push print in a case where it is determined that the information leakage risk is higher than the threshold.

In step S802, the print server 102 (for example, the detection unit 405) determines whether inhibiting push print in a case where it is determined that the information leakage risk is higher than the threshold is set by the user. Upon determining that the setting is done (“YES” in step S802), the print server 102 advances the process to step S605. Otherwise (“NO” in step S802), the print server 102 advances the process to step S608. The user may be the subject (entity) that uses the print service provided by the print server 102. The user who has set to inhibit push print may be the same as the user who has input the print instruction acquired in step S601 or may be different.

An example of a screen 910 used by the user to set whether to inhibit push print in a case where it is determined that the information leakage risk is higher than the threshold will be described with reference to FIG. 9B. The print server 102 (for example, the UI control unit 406) may display the screen 910 on the display device 207 of the client apparatus 103. The screen 910 includes two radio buttons 911 and 912. By selecting the radio button 911, the user can set not to inhibit push print in a case where it is determined that the information leakage risk is higher than the threshold. By selecting the radio button 912, the user can set to inhibit push print in a case where it is determined that the information leakage risk is higher than the threshold.

As described above, if the user or administrator does such a setting that push print is executable even in a case where it is determined that the information leakage risk is higher than the threshold, it is possible to further improve user's convenience while reducing the information leakage risk.

In the above-described modification, both the setting by the user and the setting by the administrator are taken into consideration. Instead, the setting by the user may not be taken into consideration, and in this case, step S802 is omitted in the method shown in FIG. 8. Also, the setting by the administrator may not be taken into consideration, and in this case, step S801 is omitted in the method shown in FIG. 8. Steps S801 and S802 may be executed between steps S602 and S603. In this case, only if at least one of the administrator and the user sets to inhibit push print in a case where it is determined that the information leakage risk is higher than the threshold, the information leakage risk is decided in step S603. This reduces the processing load to decide the information leakage risk.

In the above-described embodiment, the screen 700 includes the push print object 705 for designating push print to perform a print instruction and the hold printing object 706 for designating hold printing to perform a print instruction. In place of these objects, the screen 700 may include a method designation object (for example, a radio button) for designating a method, and a print instruction object (for example, a button) for performing a print instruction. In this case, a method (push print or hold printing) designated by the method designation object is notified to the print server 102 in accordance with pressing of the print instruction object.

In the above-described embodiment, the print server 102 functions as a web application server, and the client apparatus 103 accesses the web application server by the web browser. Instead, the client apparatus 103 may have a dedicated program (for example, a printer driver) used to access the print server 102. The screen 700 may be generated by the dedicated program and displayed on the display device 207 of the client apparatus 103.

In the above-described embodiment, if it is determined in step S607 that the user has input the print code to the print apparatus 101, the print server 102 transmits the print job to the print apparatus 101 in step S608. Instead of executing steps S606 to S608, the print server 102 may transmit, to the print apparatus 101, the print job according to the print instruction acquired in step S601 and the print code issued in step S605. Upon receiving the print code, the print apparatus 101 determines that the received print job should be executed by hold printing. In this case, if the print code input by the user matches the print code received from the print server 102, the print apparatus 101 executes print according to the print job. Otherwise, the print apparatus 101 may return an error.

In the above-described embodiment, the user operation necessary for starting print by hold printing is input of the print code to the print apparatus 101 by the user. Instead, another user operation may be required. For example, the user operation necessary for starting print by hold printing may be input of the ID and credential of the user himself/herself to the print apparatus 101 by the user.

In the above-described embodiment, the method shown in FIG. 6 is executed by the print server 102 located far apart from the print apparatus 101 that executes print according to a print instruction. “Located far apart” may mean that the print apparatus 101 and the print server 102 are not in physical contact. In another embodiment, the method shown in FIG. 6 may be executed by a computer incorporated in the print apparatus 101 (that is, the control device of the print apparatus 101). In this case, in step S601, the print apparatus 101 may acquire a print instruction via the print server 102, or may acquire a print instruction directly from the client apparatus 103 (that is, without interposing the print server 102). The print apparatus 101 may promote input of the print code in step S606 and execute print according to the print instruction in step S608. In still another embodiment, the method shown in FIG. 6 may be executed by the client apparatus 103. For example, a program (for example, a printer driver) installed in the client apparatus 103 may determine whether a print instruction is acquired from the user in step S601. After that, in step S608, the client apparatus 103 may instruct the print apparatus 101 to execute print via or without interposing the print server 102.

### Other Embodiments

The present invention can be implemented by processing of supplying a program for implementing one or more functions of the above-described embodiments to a system or apparatus via a network or storage medium, and causing one or more processors in the computer of the system or apparatus to read out and execute the program. The present invention can also be implemented by a circuit (for example, an ASIC) for implementing one or more functions.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-043461, filed Mar. 17, 2023, which is hereby incorporated by reference herein in its entirety.

What is claimed is:

1. An information processing apparatus comprising:
an acquisition unit configured to acquire a print instruction designated to be executed by a first method that does not need a user operation on a print apparatus to start print;
a determination unit configured to, in a case where the acquisition unit acquires the print instruction designated to be executed by the first method, determine, based on at least one of a date/time to execute print according to the print instruction and a position of the print apparatus that executes print according to the print instruction, whether an information leakage risk caused by execution of print according to the print instruction is higher than a threshold; and
an execution unit configured to execute the print instruction by the first method in a case where it is determined that the information leakage risk is lower than the threshold, and execute the print instruction by a second method that needs the user operation on the print apparatus to start print in a case where it is determined that the information leakage risk is higher than the threshold.

2. The apparatus according to claim 1, wherein in a case where the acquisition unit acquires a second print instruction designated to be executed by the second method, the execution unit executes the second print instruction by the second method regardless of whether an information leakage risk caused by execution of print according to the second print instruction is higher than the threshold.

3. The apparatus according to claim 1, wherein the determination unit determines whether the information leakage risk is higher than the threshold further based on contents of a print target designated by the print instruction and the number of pages of the print target designated by the print instruction.

4. The apparatus according to claim 1, wherein executing the print instruction by the second method includes issuing a code to be input to the print apparatus that executes print according to the print instruction.

5. The apparatus according to claim 1, wherein in a case where an administrator of the information processing apparatus sets to inhibit the first method based on a determination that the information leakage risk is higher than the threshold, in a case where the acquisition unit acquires the print instruction designated to be executed by the first method, and in a case where the determination unit determines that the information leakage risk is higher than the threshold, the execution unit executes the print instruction by the second method.

6. The apparatus according to claim 1, wherein in a case where one of a user and an administrator of the information processing apparatus sets to inhibit the first method based on a determination that the information leakage risk is higher than the threshold, in a case where the acquisition unit acquires the print instruction designated to be executed by the first method, and in a case where the determination unit determines that the information leakage risk is higher than the threshold, the execution unit executes the print instruction by the second method.

7. The apparatus according to claim 1, wherein in a case where neither a user nor an administrator of the information processing apparatus sets to inhibit the first method based on a determination that the information leakage risk is higher than the threshold, and in a case where the acquisition unit acquires the print instruction designated to be executed by the first method, the execution unit executes the print instruction by the first method.

8. The apparatus according to claim 1, wherein the information processing apparatus is located away from the print apparatus that executes print according to the print instruction.

9. The apparatus according to claim 1, wherein the information processing apparatus is incorporated in the print apparatus that executes print according to the print instruction.

10. A non-transitory computer-readable storage medium that stores instructions, wherein the instructions cause at least one processor to:
acquire a print instruction designated to be executed by a first method that does not need a user operation on a print apparatus to start print;
in a case where the print instruction designated to be executed by the first method is acquired, determine, based on at least one of a date/time to execute print according to the print instruction and a position of the print apparatus that executes print according to the print instruction, whether an information leakage risk caused by execution of print according to the print instruction is higher than a threshold;
execute the print instruction by the first method in a case where it is determined that the information leakage risk is lower than the threshold; and
execute the print instruction by a second method that needs the user operation on the print apparatus to start print in a case where it is determined that the information leakage risk is higher than the threshold.

11. An information processing method to be executed by an information processing apparatus, the method comprising:
acquiring a print instruction designated to be executed by a first method that does not need a user operation on a print apparatus to start print;
in a case where the print instruction designated to be executed by the first method is acquired, determining, based on at least one of a date/time to execute print according to the print instruction and a position of the print apparatus that executes print according to the print instruction, whether an information leakage risk caused by execution of print according to the print instruction is higher than a threshold;
executing the print instruction by the first method in a case where it is determined that the information leakage risk is lower than the threshold; and
executing the print instruction by a second method that needs the user operation on the print apparatus to start print in a case where it is determined that the information leakage risk is higher than the threshold.
